(19) United States
(12) Patent Application Publication
(10) Pub. No.: US 2008/0301949 A1
(43) Pub. Date: Dec. 11, 2008

(54) Pruning saw

(76) Inventors: Agnete Enga, Brooklyn, NY (US); Anton Ljunggren, New York, NY (US); Peter Michaelian, Tappan, NY (US); Boris Kontorovich, Brocklyn, NY (US); Anthony Di Bitonto, Brooklyn, NY (US); Alec Drummond, Brooklyn, NY (US)

Correspondence Address: SEYFARTH SHAW LLP, 131 S. DEARBORN ST., SUITE 2400, CHICAGO, IL, 60603-5803, US

(21) Appl. No.: 11/811,645

(22) Filed: Jun. 11, 2007

(51) Int. Cl. B26B 27/00

(52) U.S. Cl. 30/161; 30/166.3; 30/314

(57) ABSTRACT

A pruning saw comprising a handle, a retractable blade pivotably connected to the handle, and a safety latch is disclosed. The handle includes first and second ends, top and bottom surfaces and a longitudinal recess beginning at the first end and extending along the bottom surface toward the second end, while the retractable blade is pivotably connected to the handle at the first end. The blade is capable of pivoting between an open and extended position substantially aligned with the handle and a closed and retracted position concealed within the longitudinal recess of the handle. Accordingly, the safety latch retains the blade in at least one of either the open and extended position and the closed and retracted position. Actuation of the safety latch releases the blade to move freely between the open and closed positions, the safety latch being responsive to at least two buttons positioned on the handle.

### TECHNICAL FIELD OF THE INVENTION

The present device relates to pruning saws. Particularly, the present device relates to a collapsible pruning saw having a safety feature to minimize injury to the user.

### BACKGROUND OF THE INVENTION

Handsaws of the type called pruning saws by craftsmen are used not only by professionals for gardening and landscaping, but also by non-professionals for chores such as pruning plants and cutting trees, shrubs and the like. For convenience of storage and safety, the industry has designed a pruning saw with a retractable blade. However, existing pruning saws with extendable blades can be bulky, inconvenient and unsafe to extend and retract, and hazardous to carry and store due to the possibility of inadvertently opening.

The present pruning saw has been designed with safety being of paramount importance. While prior art devices have failed to properly address the safety of the user's hands and fingers with these retractable blade saws, the present device addresses the need by presenting a safe and secure latch which resists inadvertent blade release.

### SUMMARY OF THE INVENTION

There is disclosed herein an improved pruning saw which avoids the disadvantages of prior devices while affording additional structural, operating and safety advantages.

In general, a pruning saw comprising a handle, a retractable blade pivotably connected to the handle, and a safety latch is disclosed. In a preferred embodiment, the handle includes first and second ends, top and bottom surfaces and a longitudinal recess beginning at the first end and extending along the bottom surface toward the second end, while the retractable blade is pivotably connected to the handle at the first end. The blade is capable of pivoting between an open and extended position substantially aligned with the handle and a closed and retracted position concealed within the longitudinal recess of the handle. Accordingly, it is an aspect of the invention to employ the safety latch for retaining the blade in at least one of either the open and extended position and the closed and retracted position, wherein actuation of the safety latch releases the blade to move freely between the open and closed positions, the safety latch comprising at least two buttons positioned on the handle for actuation.

In an embodiment of the invention, the two buttons move in opposite directions for actuation of the safety latch. The two buttons may also be configured to move in the same direction for actuation of the safety latch.

It is a further aspect of an embodiment of the invention to provide a spring stop positioned within the handle such that the spring contacts the blade to impede (i.e., slow) movement of the blade toward the closed position. The blade preferably comprises an attachment portion secured to pivot about an axis within the handle and transverse to the longitudinal recess, the attachment portion comprising at least one slot, and preferably two slots, capable of being engaged by the safety latch. A first slot is used to retain the blade in the open and extended position, while a second slot retains the blade in the closed and retracted position.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of one embodiment of the pruning saw illustrating the use of the multiple buttons;

FIG. 2 is a top view of an embodiment of the present pruning saw with the blade in a closed and retracted position;

FIG. 3 is a side view of the pruning saw shown in FIG. 2;

FIG. 4 is a top view of an embodiment of the present pruning saw with the blade in an open and extended position;

FIG. 5 is a side view of the pruning saw shown in FIG. 4;

FIG. 6 is a top cut-away of an embodiment of the two-buttons engaging the blade safety latch showing the blade in an extended position;

FIG. 7 is a side view of the blade safety latch shown in FIG. 6;

FIGS. 8 and 9 are top views of an embodiment of the safety latch showing unlocked and locked positions, respectively;

FIG. 10 is a side view of the safety latch of FIG. 9;

FIG. 11 is a perspective view of the safety latch of FIG. 9;

FIG. 12 is a partial cut away view of the blade in an locked open position;

FIG. 13 is a partial cut away view of the blade engaging a spring stop to slow movement toward the closed position;

FIGS. 14-16 illustrate an alternative embodiment of the safety latch using offset fingers; and

FIGS. 17 and 18 are partial cut away views of an embodiment of the pruning saw using the alternative safety latch of FIGS. 14-16.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

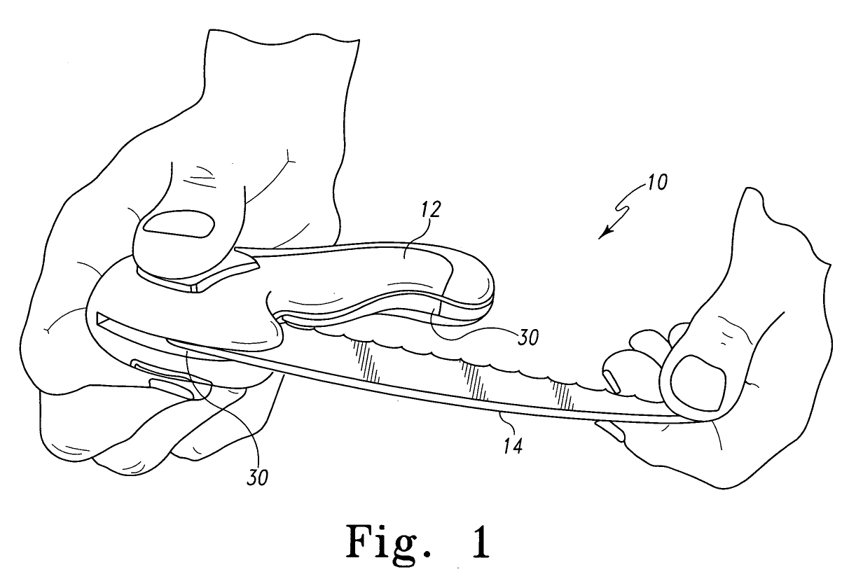

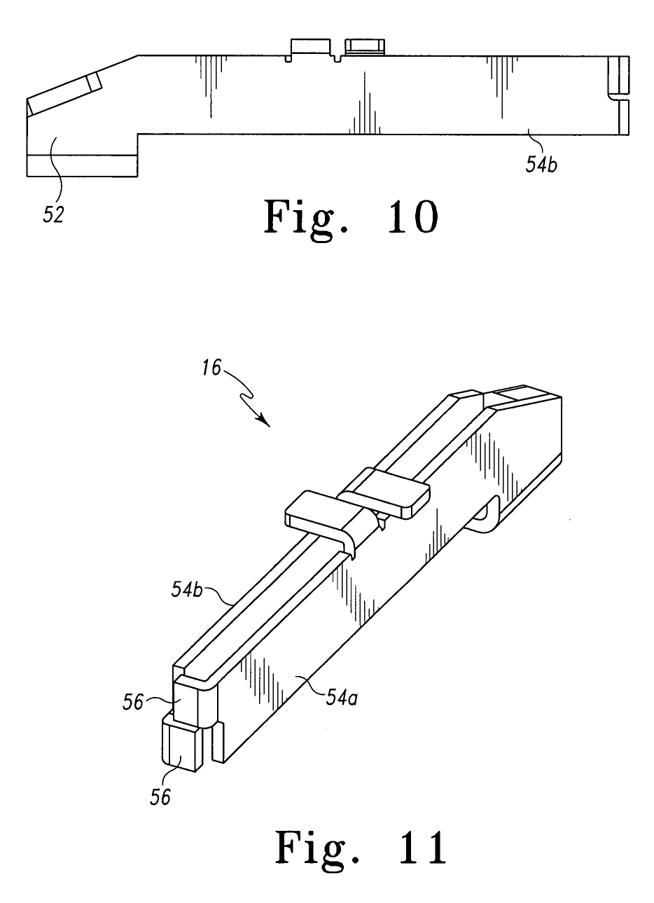

Referring to FIGS. 1-18, there is illustrated embodiments of a pruning saw, generally designated by the numeral 10, and its various components. The pruning saw 10 has a handle 12, a retractable blade 14 pivotably connected to the handle 12, and a safety latch 16 for retaining the blade 14 in a locked safety position. FIG. 1 illustrates a preferred operation of the pruning saw 10, requiring the depression of two buttons 18a and 18b on the handle 12 with one hand and the movement of the blade 14 between open and closed positions, by the other hand.

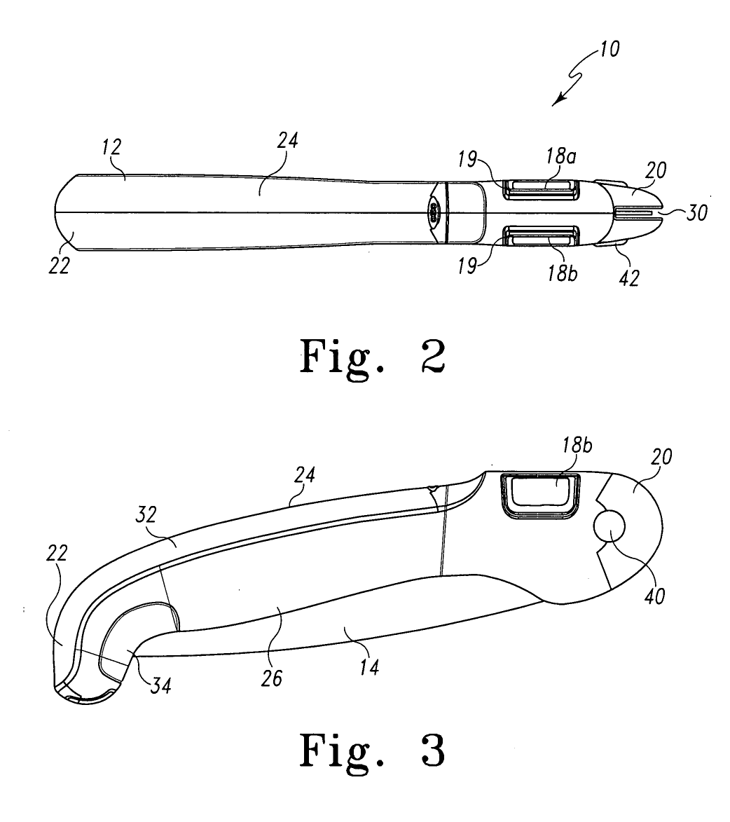

Referring specifically to FIGS. 2 and 3, the pruning saw 10 is shown with the blade 14 in the closed and retracted position. The handle 12 is preferably sleek and ergonomic in design to provide comfort to the hand of the user. The handle 12 has a first end 20 and a second end 22, a top surface 24 and bottom surface 26 and a longitudinal recess 30 (see FIG. 1) beginning at the first end 20 and extending along the bottom surface 26 toward the second end 22.

The two buttons, 18a and 18b, are positioned on the top surface 24 proximate the first end 20 of the handle 12. Preferably, the buttons, 18a and 18b, are positioned within recessed areas 19 on opposing sides of the handle 12, as best illustrated in FIG. 2. The handle 12 may be comprised of a hard plastic, metal or other suitable material, and may include a soft grip areas, for example, at areas 32 and 34, comprised of a thermoplastic rubber, such as SANTOPRENE®. The handle 12 may also include other components for facilitating carrying of the saw 10, such as a belt clip (not shown), a ring (not shown), a carrying/hand strap, and other such devices.

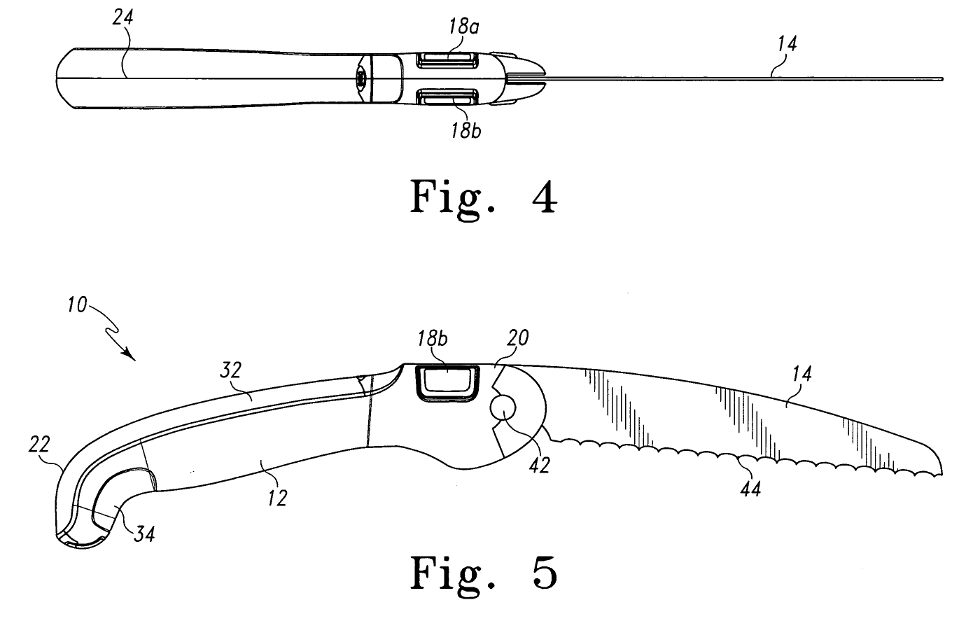

Referring now to FIGS. 4 and 5, the open and extended position of the blade 14 can be seen. When extended, the blade 14 is substantially longitudinally aligned with the handle 12. FIG. 4 shows the blade 14 extending from the portion of the recess 30 at the first end 20 of the handle 12. The recess 30 is shown to actually extend to the top surface 24 of the handle 12 to allow the back of the blade 14 to align with the top surface 24 of the handle 12. Of course, other configurations are certainly possible.

A pivot point 40 can also be seen in FIG. 5, as it extends from one side of the handle 12. The pivot point 40 consists of a pin 42 inserted transverse to and housed within the handle 12. The pin 42 provides an axis about which the blade 14 pivots from the open and extended position (FIG. 5) to the closed and retracted position (FIG. 3).

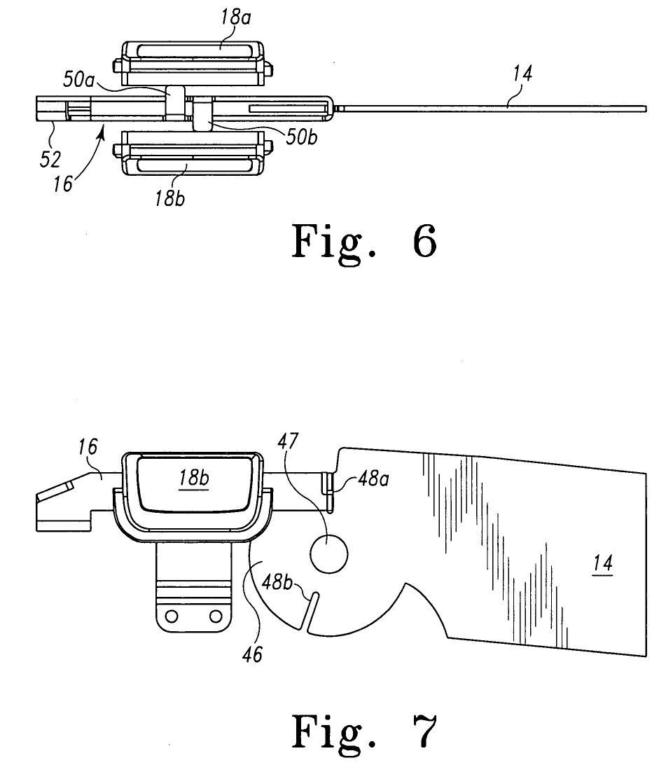

Remaining with FIG. 5, the blade 14 is shown to have an exterior segment having cutting teeth 44 along one edge and smooth along the opposing edge. Any suitable formation of teeth would be possible and thus forms no part of the present invention. An interior segment of the blade 14 is more readily understood with reference to FIGS. 6 and 7.

FIGS. 6 and 7 illustrate the safety latch 16 as it retains the blade 14 in an extended position. The interior segment of the blade 14 is comprised of an attachment portion 46 having a semi-circular shape. The attachment portion 46 is secured within the handle by pin 42, which passes through aperture 47 and is affixed at each end to the sides of handle 12. The attachment portion 46 comprises at least one, and preferably two slots 48a and 48b to facilitate locking of the blade 14 in open and closed positions, respectively.

FIG. 6, a top view of the blade safety latch 16, shows tabs 50a and 50b contacting buttons 18a and 18b, respectively. This configuration allows buttons 18a and 18b to actuate the safety latch 16 to release the blade 14 from the open or closed position, allowing the user to move the blade 14 freely between the two positions. The actuation of the safety latch 16 is explained in more detail below.

FIG. 7 shows the safety latch 16 locked into the first slot 48a of the attachment portion 46 to retain the blade 14 in the extended position. The second slot 48b is shown positioned at the lower end of the attachment portion 46 when the blade 14 is locked open.

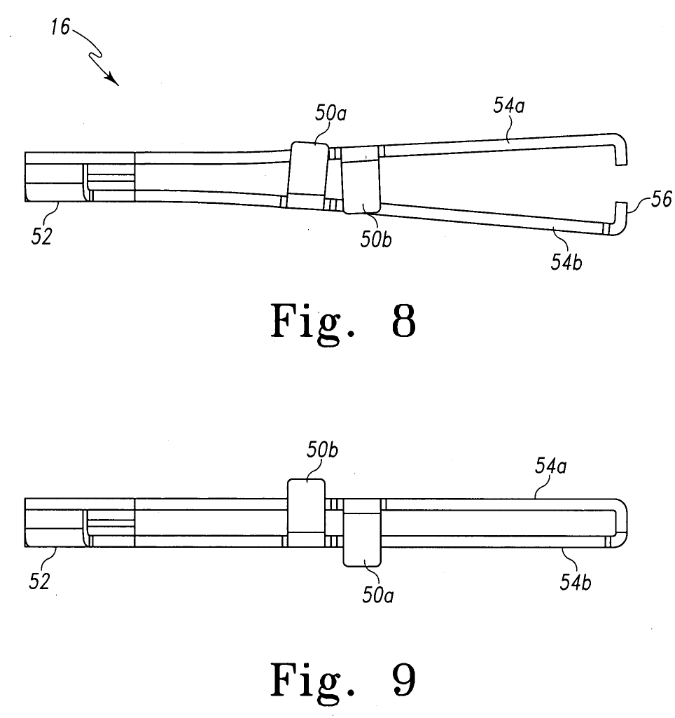

FIGS. 8-11 illustrate the actuation of the safety latch 16. The safety latch 16 is comprised of a channel member 52 having two flexible arms 54a and 54b extending there from, each arm having a finger 56 affixed to an end at approximately perpendicular to the arm, and tabs 50a and 50b affixed to the top surface of the arm 54. When the blade 14 (FIG. 6) is locked in position (open or closed), the overlapping fingers reside within one of the two slots 48a or 48b of the attachment portion 46 of the blade 14. Referring to FIG. 8, the movement of tabs 50a and 50b in the direction of the respective arrows, causes the arms 54a and 54b to flex outward from a central axis of the channel member 52. The fingers 56 are thusly removed from the slot 48a or 48b of the attachment portion 46, and the blade 14 is accordingly released. The fingers 56 are kept apart by the metal attachment portion 46 until the blade 14 is pivoted to one of the two positions corresponding to a slot on the attachment portion 46. When a slot is reached, the fingers 56 are immediately biased into the slot 48 due to the tension created at the non-flexing channel member 52. The safety latch 16 is preferably secured within the handle 12 at the channel member 52 so as not to interfere with the operation of the safety latch 16 itself.

The disclosed operation is merely a preferred configuration of the present safety latch, variations, such as additional slots on the attachment portion, or a different configuration altogether for locking the blade 14 in place, are certainly conceivable. The key in the present device is the use of two buttons, whether operating in the same or different directions, to actuate the release of the blade. As previously stated, this configuration requires the use of two hands by the operator, thereby making sure such hands are not in the way of the closing blade.

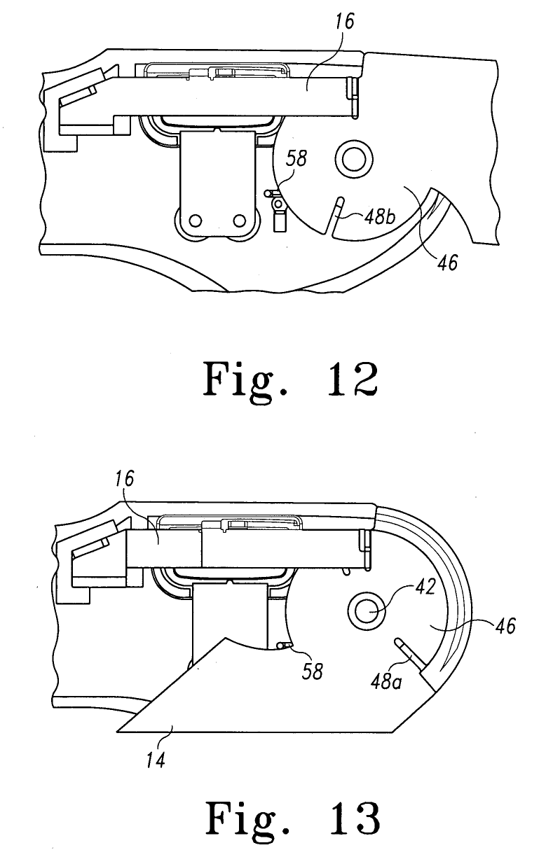

Another aspect of the present invention is illustrated in FIGS. 12 and 13. A spring stop 58 is positioned and fixed within the handle 12 of saw 10 to engage the blade 14 just before it reaches the closed position (FIG. 13). The spring stop 58, which may be comprised of any number of suitable spring types, compresses or coils upon contact by the blade 14. When the blade 14 is in the closed position (FIG. 3), the spring stop 58 is at its greatest tension. Upon release of the blade 14 by the safety latch 16, the spring stop 58 responds by uncompressing to push outward against the blade 14. This configuration serves two purposes. First, as the blade 14 closes, it engages the spring stop 58 to impede the movement. This prevents the blade 14 from quickly slamming closed on the fingers of the user. Second, upon release of the blade 14 from the closed position, as described above, the blade 14 is sprung outward from the handle 12. This negates the need of the user from having to pry the blade 14 from the handle 12, an unsafe undertaking which is otherwise required of prior devices.

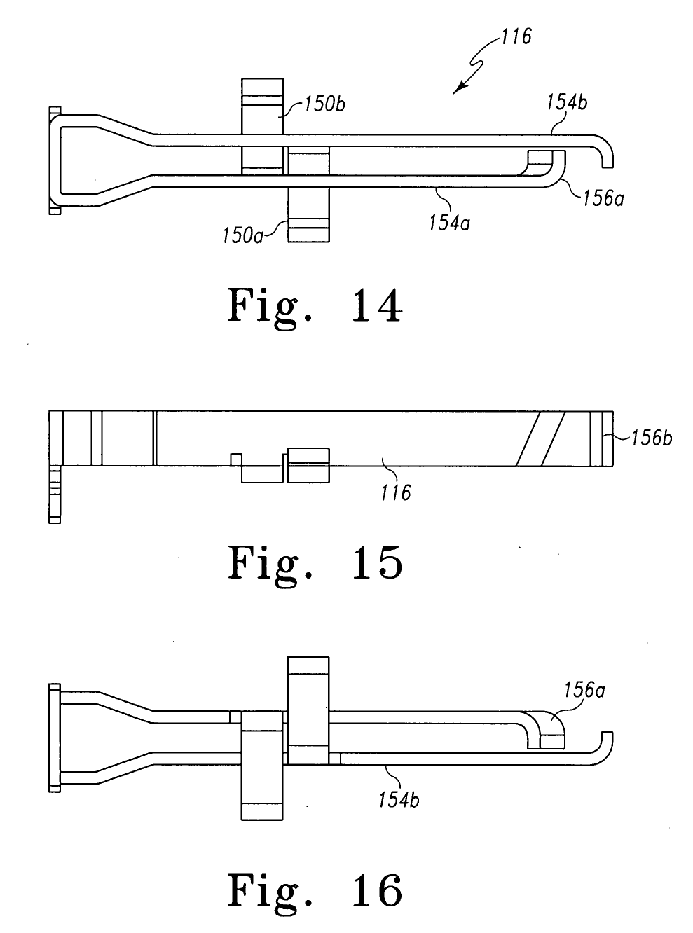

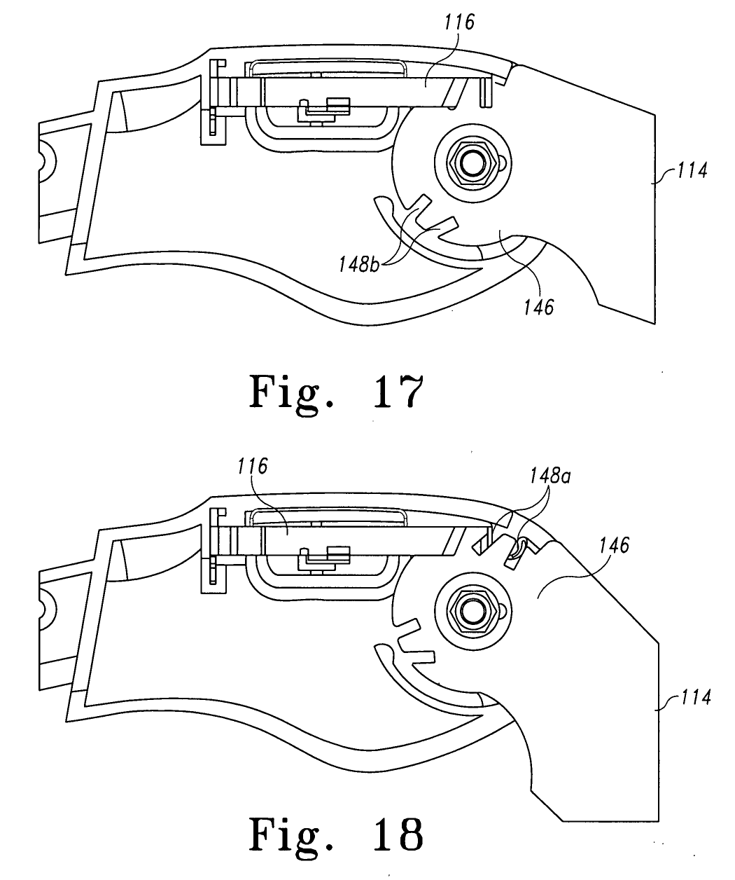

In an alternative embodiment, as shown in FIGS. 14-16, the safety latch 116 is comprised of arms 154a and 154b. These arms 154a and 154b are of unequal lengths. Also, one of the fingers 156a at the end of arm 154a (i.e., the short arm) is angled. The benefit of this configuration is made apparent in FIGS. 17 and 18. The safety latch 116 still requires the depressing of two buttons (not shown) to contact tabs 150a and 150b and release the blade 114.

FIGS. 17 and 18 illustrate a blade 114 locked in the open and extended position and then released and traveling toward a closed position. Attachment portion 146 includes two pair of slots 148a and 148b. One slot in each pair is angled to receive finger 156a. The double slots allow for greater finger widths to be used in retaining the blade 114 in position—i.e., the fingers do not have to be halved to share a slot. Angling a slot ensures that the fingers 156 can only align in the desired orientation for each pair of slots. Naturally, other configurations of slot angles or the like for indexing and retaining the blade are possible.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A pruning saw comprising:
a. a handle having first and second ends, top and bottom surfaces and a longitudinal recess beginning at the first end and extending along the bottom surface toward the second end;
b. a retractable blade pivotably connected to the handle at the first end, wherein the blade is capable of pivoting between an open and extended position substantially aligned with the handle and a closed and retracted position concealed within the longitudinal recess of the handle; and
c. a safety latch for retaining the blade in at least one of either the open and extended position and the closed and retracted position, wherein actuation of the safety latch releases the blade to move freely between the open and closed positions, the safety latch comprising at least two buttons positioned on the handle for actuation.

2. The pruning saw of claim 1, wherein the two buttons move in opposite directions for actuation of the safety latch.

3. The pruning saw of claim 1, wherein the two buttons move in the same direction for actuation of the safety latch.

4. The pruning saw of claim 1, further comprising a spring stop positioned within the handle such that the spring contacts the blade to impede movement of the blade toward the closed position.

5. The pruning saw of claim 1, wherein the blade comprises an attachment portion secured to pivot about an axis within the handle and transverse to the longitudinal recess, the attachment portion comprising at least one slot capable of being engaged by the safety latch.

6. The pruning saw of claim 5, wherein the attachment portion comprises at least two slots, including a first slot capable of being engaged by the safety latch to retain the blade in the open and extended position and a second slot capable of being engaged by the safety latch to retain the blade in the closed and retracted position.

7. The pruning saw of claim 6, wherein the safety latch comprises tabs capable of entering the first and second slots of the attachment portion of the blade.

8. The pruning saw of claim 1, wherein the safety latch further comprises two lever arms, each lever arm responsive to one of the buttons.

9. The pruning saw of claim 8, wherein the blade comprises an attachment portion secured to pivot about an axis within the handle and transverse to the longitudinal recess, the attachment portion comprising at least one slot capable of being engaged by the lever arms of the safety latch.

10. A pruning saw comprising:
a. a handle;
b. a retractable blade pivotably connected to the handle; and
c. a safety latch for retaining the blade in at least one of either an open and extended position and a closed and retracted position, the safety latch comprising at least two buttons positioned on the handle for releasing the blade.

11. The pruning saw of claim 10, wherein the two buttons move in opposite directions to release the blade from the safety latch.

12. The pruning saw of claim 10, wherein the two buttons move in the same direction to release the blade from the safety latch.

13. The pruning saw of claim 10, further comprising a spring stop positioned within the handle such that the spring contacts the blade to impede movement of the blade toward the closed position.

14. The pruning saw of claim 10, wherein the blade comprises an attachment portion secured to pivot about an axis within and transverse to the handle, the attachment portion comprising at least one slot capable of being engaged by the safety latch.

15. The pruning saw of claim 14, wherein the attachment portion comprises two slots, including a first slot capable of being engaged by the safety latch to retain the blade in the open and extended position and a second slot capable of being engaged by the safety latch to retain the blade in the closed and retracted position.
